(19) United States
(12) Patent Application Publication
(10) Pub. No.: US 2003/0041278 A1
(43) Pub. Date: Feb. 27, 2003

(54) Disk array control apparatus

(75) Inventor: Tse-Ming Lin, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: ICP Electronics Inc.

(21) Appl. No.: 10/067,679

(22) Filed: Feb. 4, 2002

(30) Foreign Application Priority Data
Aug. 24, 2001 (TW) 90120825

(51) Int. Cl. G06F 11/00

(52) U.S. Cl. 714/1

(57) ABSTRACT

The present invention provides a disk array control apparatus comprising a disk array control unit, an interface converter and a network interface unit. The disk array control unit has a parallel interface for transmitting and receiving a plurality of parallel signals and a shared bus interface for transmitting and receiving stored data. The interface converter converts the parallel signals into corresponding differential signals when receiving the parallel signals from the disk array control unit, and converts a plurality of external differential signals into the corresponding parallel signals when the disk array control unit receiving data from the parallel interface. The network interface unit has a network I/O port connecting with an external network. The network interface unit is also connected to the shared bus interface. The stored data is passed from the shared bus interface through the network I/O port to the external network, and the remote data is passed from the external network through the network I/O port to the shared bus interface.

### BACKGROUND OF THE INVENTION

1. Field of the Invention

The present invention relates in general to a disk array control apparatus, in particular, to a disk array control apparatus for network storage devices.

2. Description of the Related Art

With the fast growth of network using and booming data flow, network storage device that is secure, reliable, and efficient has become a major IT market priority. Many types of network storage devices, such as Network Attached Storage (NAS), Storage Area Network (SAN), or Redundant Arrays of Independent Disks (RAID) servers, usually use disk array devices with disk fault tolerance. The hard disk drive using Integrated Drive Electronics (IDE)/AT Attachment (ATA) interface has been used in disk array equipments due to lower costs. However, in a standard IDE/ATA interface, 40 signal lines are used in parallel to implement data transmission, and the standard maximum transmitting length is 18 inches. Such a short connecting distance and the excessive signal lines shall cause a problem in cable distribution when several IDE/ATA hard disk drives are arranged as disk array equipment.

### SUMMARY OF THE INVENTION

An object of the present invention is to keep the efficiency and advantages over the cost of IDE/ATA hard disk drives, and to reduce the number of interface signals and increase transmission length, thereby solving the problem of cable distribution in the conventional disk array apparatus, while connecting the disk array apparatus to the network to perform remote data storage management.

To implement the object described above, the present invention provides a disk array control apparatus converting the IDE/ATA interface signals into compact differential signals to reduce the amount of interface signals, and to increase the transmitting length. Further, the disk array control apparatus provides network connection.

The disk array control apparatus comprises a disk array control unit, an interface converter and a network interface unit. The disk array control unit has a parallel interface for transmitting and receiving a plurality of parallel signals and a shared bus interface for transmitting and receiving stored data. The interface converter converts the parallel signals received from the disk array control unit into corresponding differential signals and converts a plurality of external differential signals into the corresponding parallel signals which are then output to the parallel interface. The network interface unit has a network I/O port connecting with an external network. The network interface unit is also connected to the shared bus interface. The stored data is passed from the shared bus interface through the network I/O port to the external network, and remote data is passed from the external network through the network I/O port to the shared bus interface.

### BRIEF DESCRIPTION OF THE DRAWINGS

The present invention can be more fully understood by reading the subsequent detailed description in conjunction with the examples and references made to the accompanying drawings, wherein:

FIG. 1 is a block diagram of the network storage device according to the present invention;

FIG. 2 shows the block diagram of the interface converter of the present invention;

FIG. 3 is a block diagram of the interface converter of the disk array apparatus connecting to the present invention; and

FIG. 4 is a block diagram of the network interface unit of the present invention.

### DETAILED DESCRIPTION OF THE PREFERRED EMBODIMENT

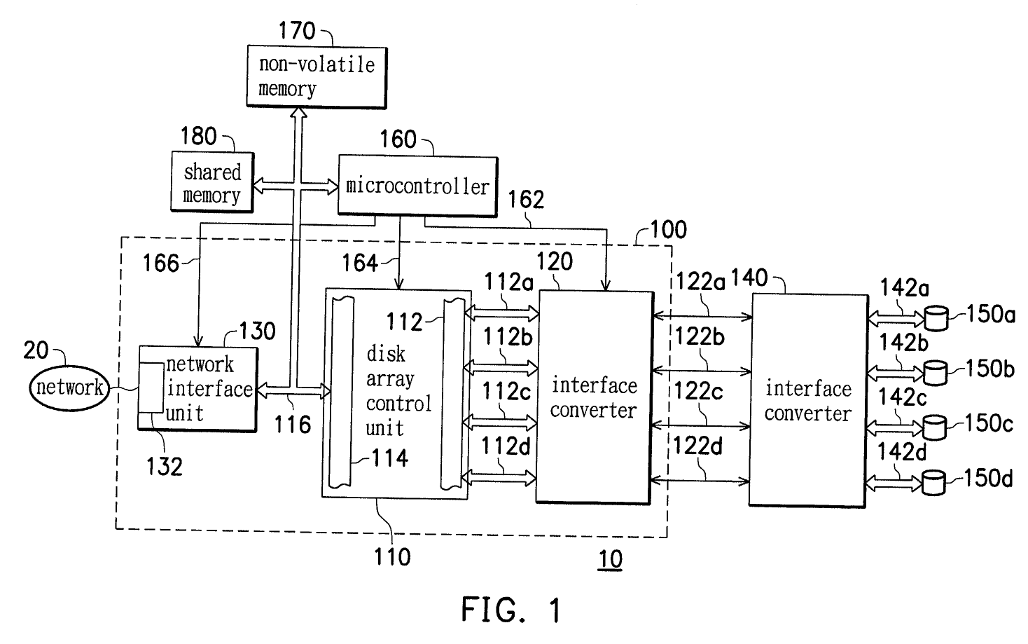

FIG. 1 is a block diagram of the network storage device according to the present invention. As shown in FIG. 1, the network storage device 10 comprises a disk array control apparatus 100, a disk array apparatus comprising a plurality of disk devices 150a˜150d and its relevant interface converter 140. The disk devices 150a˜150d are IDE/ATA hard disk drives. Each of the IDE/ATA hard disk drives 150a˜150d provides a set of IDE/ATA interface signal 142a˜142d. The disk array control apparatus 100 comprises: a disk array control unit 110, an interface converter 120 and a network interface unit 130. A microcontroller 160 controls the disk array control unit 110, the interface converter 120 and the network interface unit 130 through control signals 162-166. The microcontroller 160 reads data and firmware programs in a non-volatile memory 170 through the shared bus 116 to control the data flow and perform the storage management. Data is exchanged between the disk array control unit 110, the microcontroller 160 and the network interface unit 130, and can be stored temporarily in a shared memory 180. The microcontroller 160, non-volatile memory 170 and shared memory 180 can be incorporated into the disk array control unit 110 by anyone skilled in the art. The present invention uses four IDE/ATA hard disk drives 150a˜150d to form the disk array apparatus as an example for illustration only. The number of the disk drives can be changed accordingly. As shown in FIG. 1, the disk array control unit 110 has a parallel interface (IDE/ATA interface 112) for transmitting and receiving a plurality of parallel signals (IDE/ATA signals 112a˜112d), and a shared bus interface 114 for transmitting and receiving stored data. The disk array control unit 110 is a controller of Redundant Array of Independent Drives (RAID) increasing the input/output efficiency of the disk array apparatus with duplicated spare-data and disk fault tolerance. The disk array control unit 110 provides four RAID levels: RAID 0, RAID 1, RAID 5 and RAID 0+1 to satisfy numerous requirements. RAID 0 is a striped disk array without fault tolerance. The data is broken down into blocks and each block is stored in a separate disk drive. The I/O performance is greatly improved by spreading the I/O load across many channels and drives. RAID 1 implements disk mirroring; data is duplicated in a mirrored pair. RAID 5 is independent data disks with distributed parity blocks; if there are four disks, for each disk, 75% of the capacity is used to store major data, the other 25% is used to store Hamming error correction code (ECC) of parity blocks in the same rank so that the data could be automatically recovered after being damaged. RAID 0+1 is implemented as a mirrored array whose segments are RAID 0 arrays. The implementation of RAID 0 and RAID 1 separately require at least two disk drives, and the implementation of RAID 5 requires at least three and RAID 0+1 requires at least 4 disk drives. In addition, disk array control unit 110 supplies IDE/ATA standards (ATA-66 and ATA-100) reading and writing at DMA mode speeds of 66 MB/s and 100 MB/s. In the embodiment of the present invention, the disk array control unit 110 reads and writes the 4 IDE/ATA hard disk drives 150a˜150d simultaneously. If each of the IDE/ATA hard disk drives 150a˜150d adopts the ATA-66 standard, the throughput of the disk array control unit 110 is summed up to 264 MB. The number of the IDE/ATA hard disk drives read and written by the disk array control unit 110 is determined according to the practical situations. The interface converter 120 converts the IDE/ATA signals 112a˜112d to the corresponding differential signals 122a˜122d when receiving the IDE/ATA signals 112a˜112d from the IDE/ATA interface 112, and converts the differential signals 122a˜122d into the corresponding IDE/ATA signals 112a˜112d when the disk array control unit 110 receives data from the interface converter 120. The network interface unit 130 has a network I/O port 132 connecting with an external network 20. The network interface unit 130 is coupled to the disk array control unit 110 through the shared bus interface 114 to receive the stored data from the shared bus 116 then passed through the network I/O port 132 to the external network 20, and the remote data is passed from the external network 20, through the network I/O port 132 to the shared bus 116. The interface converter 140 relating to the disk array apparatus receives the disk interface signals 142a˜142d from the IDE/ATA hard disk drives 150a˜150d and converts the signals into corresponding differential signals 122a˜122d then output to the interface converter 120. The interface converter 140 also converts the differential signals 122a˜122d received from the interface converter 120 to the corresponding disk interface signals 142a˜142d for the IDE/ATA hard disk drives 150a˜150d.

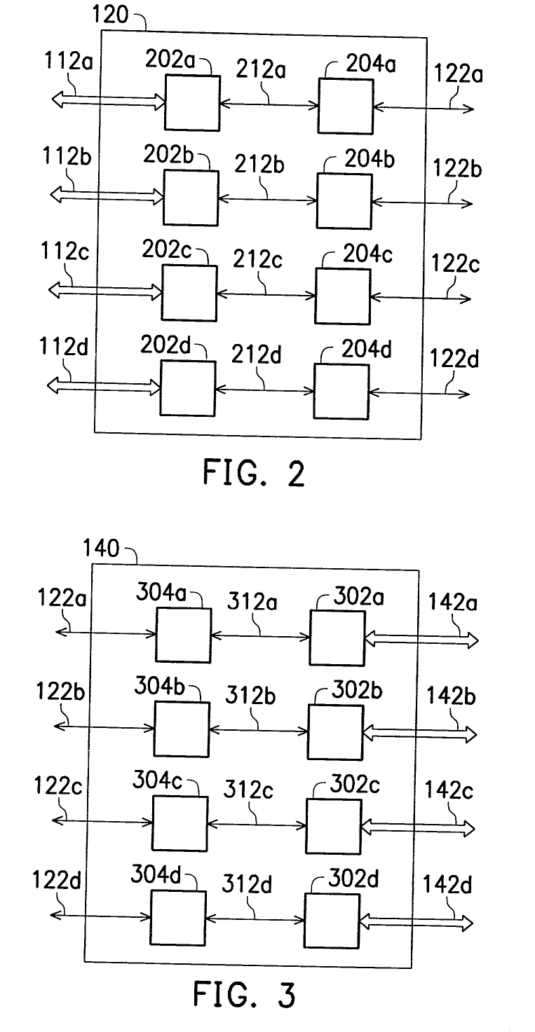

FIG. 2 shows the block diagram of the interface converter 120 of the present invention. The interface converter 120 comprises four parallel-to-serial signal converters 202a˜202d, and four differential transceivers 204a˜204d. When the disk array control unit 110 transmits data to the interface converter 120, the parallel-to-serial signal converters 202a˜202d receives the IDE/ATA signals 112a˜112d from the disk array control unit 110 and respectively convert the IDE/ATA signals 112a˜112d into four corresponding high speed digital serial signals 212a˜212d which are then converted into the corresponding differential signals 122a˜122d by the differential transceivers 204a˜204d. Conversely, when the interface converter 120 transmits data to the disk array control unit 110, the differential transceivers 204a˜204d respectively convert the differential signals 122a˜122d into the corresponding high speed digital serial signals 212a˜212d and the parallel-to-serial signal converters 202a˜202d convert the four digital serial signals 212a˜212d into the four corresponding IDE/ATA signals 112a˜112d.

FIG. 3 is a block diagram of the interface converter 140 of the disk array apparatus connecting to the present invention. As shown in FIG. 3, the interface converter 140 comprises four parallel-to-serial signal converters 302a˜302d and four differential transceivers 304a˜304d. The four parallel-to-serial signal converters 302a˜302d respectively convert the four disk interface signals 142a˜142d received from the IDE/ATA hard disk drives 150a˜150d into four corresponding high speed digital serial signals 312a˜312d and the four differential transceivers 304a˜304d convert the digital serial signals 312a˜312d into four corresponding differential signals 122a˜122d when the IDE/ATA hard disk drives 150a˜150d transmit data to the interface converter 140. Conversely, differential transceivers 304a˜304d convert the differential signals 122a˜122d into the corresponding high speed digital serial signals 132a˜312d and the parallel-to-serial converter 302a˜302d convert the four digital serial signals 312a˜312d into the four corresponding disk interface signals 142a˜142d when the interface converter 140 receives data from the interface converter 120.

In the embodiment of the present invention, the differential transceivers 304a˜304d and the differential transceivers 204a˜204d are low voltage differential signal (LVDS) transceivers. The differential signals generated by the LVDS transceivers have the advantages of low noise, low power consumption, high transmission speed and a long transmitting length of up to ten meters. The present invention converts a set of 40 IDE/ATA parallel signal lines into a set of differential signal lines such that each differential signal set contains 10 signal lines even comprising the power-supply and the ground signals, thereby reducing the complexity of cable distribution.

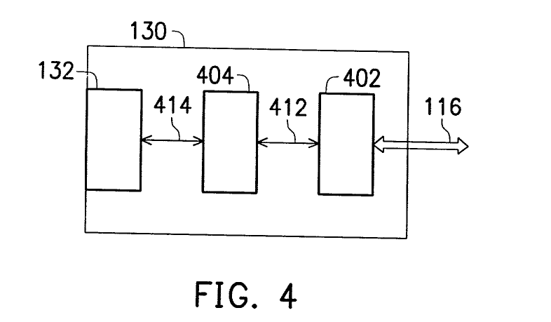

FIG. 4 shows a block diagram of the network interface unit 130 of the present invention. A media access control (MAC) circuit 402 converts the stored data from the shared bus interface 114 into a bitstream compliant with an Ethernet MAC layer protocol through the shared bus 116 when the network storage device 10 transmits data to the external network 20, and converts the bitstream to a format compatible with the shared bus interface 114 when the network storage device 10 receives data from the external network 20. A physical circuit 404 is coupled to the MAC circuit 402 and the network I/O port 132 respectively through signals lines 412 and 414. The physical circuit 404 exchanges the bitstream from the MAC circuit 402 with a network physical signal of the remote data transmitting through the network I/O port 132. With the aid of the network interface unit 130, the network storage device 10 is connected with the network directly and performs remote storage management. In the present invention, the network 20 is not limited to a specific type of network. Both wire and wireless network are included in the scope of the present invention.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A disk array control apparatus, comprising:
a disk array control unit, having a parallel interface for transmitting and receiving a plurality of parallel signals and a shared bus interface for transmitting and receiving stored data;
an interface converter, for converting the plurality of parallel signals from the disk array control unit into a plurality of corresponding differential signals and converting a plurality of external differential signals into the plurality of corresponding parallel signals which is then output to the parallel interface; and
a network interface unit, having a network I/O port connecting with an external network, the network interface unit connected to the shared bus interface, for passing the stored data from the shared bus interface through the network I/O port to the external network, and for passing remote data from the external network through the network I/O port to the shared bus interface.

2. The disk array control apparatus as claimed in claim 1, wherein the interface converter comprises:
a plurality of parallel-to-serial signal converters, for receiving and converting the parallel signals into a plurality of corresponding digital serial signals when the disk array control unit transmits data to the interface converter, and for converting the digital serial signals into corresponding parallel signals when the interface converter transmits data to the disk array control unit; and
a plurality of differential transceivers, for converting the digital serial signals into a plurality of corresponding differential signals when the disk array control unit transmits data to the interface converter, and for converting the differential signals into corresponding digital serial signals when the interface converter transmits data to the disk array control unit.

3. The disk array control apparatus as claimed in claim 2, wherein the differential transceiver is a low voltage differential signal (LVDS) transceiver.

4. The disk array control apparatus as claimed in claim 1, wherein the disk array control unit is a Redundant Array of Independent Drives (RAID) controller, providing at least two RAID levels for disk fault tolerance.

5. The disk array control apparatus as claimed in claim 1, wherein the parallel interface satisfies an IDE/ATA standard.

6. The disk array control apparatus as claimed in claim 1, wherein the network interface unit comprises:
a media access control (MAC) circuit, for converting the stored data from the shared bus interface into a bitstream compliant with an Ethernet MAC layer protocol when the disk array control apparatus transmits data to the external network, and converting the bitstream to a format compatible with the shared bus interface when the disk array control apparatus receives data from the external network; and
a physical circuit, for exchanging the bitstream from the MAC circuit with a network physical signal of the remote data.

7. A network storage apparatus comprising:
a plurality of disk devices, each providing a disk interface signal;
a disk array control unit, having a parallel interface for transmitting and receiving a plurality of parallel signals and a shared bus interface for transmitting and receiving stored data;
a first interface converter, for converting the plurality of parallel signals from the disk array control unit into a plurality of corresponding differential signals and converting a plurality of external differential signals into the corresponding plurality of parallel signals which is then output to the parallel interface;
a second interface converter, for converting the disk interface signals into the plurality of corresponding differential signals received by the first interface converters, and converting the plurality of differential signals from the first interface converter into the corresponding disk interface signals which is then output to the disk devices; and
a network interface unit, having a network I/O port connecting with an external network, the network interface unit connected to the shared bus interface, for passing the stored data from the shared bus interface through the network I/O port to the external network, and for passing remote data from the external network through the network I/O port to the shared bus interface.

8. The network storage apparatus as claimed in claim 7, wherein the first interface converter comprises:
a plurality of first parallel-to-serial signal converters, receiving and converting the plurality of parallel signals into a plurality of corresponding first digital serial signals when the disk array control unit transmits data to the first interface converter, and converting the plurality of first digital serial signals into the plurality of corresponding parallel signals when the first interface converter transmits data to the disk array control unit; and
a plurality of first differential transceivers, converting the first digital serial signals into a plurality of corresponding differential signals when the disk array control unit transmits data to the first interface converter, and converting the differential signals into corresponding first digital serial signals when the first interface converter transmits data to the disk array control unit.

9. The network storage apparatus as claimed in claim 7, wherein the second interface converter comprises:
a plurality of second parallel-to-serial signal converters, converting the disk interface signals into a plurality of corresponding second digital serial signals when the disk device transmits data to the second interface converter, and converting the plurality of second digital serial signals into the corresponding disk interface signals when the second interface converter transmits data to the disk device; and
a plurality of second differential transceivers, converting the second digital serial signals into the plurality of corresponding differential signals when the disk device transmits data to the second interface converter, and converting the plurality of differential signals into the plurality of corresponding second digital serial signals when the first interface converter transmits data to the second interface converter.

10. The network storage apparatus as claimed in claim 9, wherein the first and second differential transceivers are low voltage differential signal (LVDS) transceivers.

11. The network storage apparatus as claimed in claim 7, wherein the disk array control unit is a Redundant Array of Independent Drives (RAID) controller providing at least two RAID levels for disk fault tolerance.

12. The network storage apparatus as claimed in claim 7, wherein the parallel interface is IDE/ATA compatible.

13. The network storage apparatus as claimed in claim 7, wherein the disk interface signal is IDE/ATA compatible.

14. The network storage apparatus as claimed in claim 7, wherein the network interface unit comprises:
a media access control (MAC) circuit, converting the stored data from the shared bus interface into a bitstream compliant with an Ethernet MAC layer protocol when the network storage apparatus transmits data to the external network, and for converting the bitstream to a format compatible with the shared bus interface when the network storage apparatus receives data from the external network; and
a physical circuit, exchanging the bitstream from the MAC circuit with a network physical signal of the remote data.
